(19) United States
(12) Patent Application Publication
(10) Pub. No.: US 2018/0088927 A1
(43) Pub. Date: Mar. 29, 2018

(54) ROOT OF TRUST (RoT) APPLICATION FOR INTERNET OF THINGS (IoT) DEVICES

(71) Applicant: Intel Corporation, Santa Clara, CA (US)

(72) Inventors: LI ZHAO, Beaverton, OR (US); RAFAEL MISOCZKI, Hillsboro, OR (US); SANTOSH GHOSH, Hillsboro, OR (US); MANOJ R. SASTRY, Portland, OR (US)

(73) Assignee: Intel Corporation, Santa Clara, CA (US)

(21) Appl. No.: 15/278,658

(22) Filed: Sep. 28, 2016

(51) Int. Cl. G06F 9/445; G06F 9/44; H04L 9/30; H04L 9/32; H04L 9/06; H04L 29/06

(52) U.S. Cl. CPC G06F 8/65; G06F 9/4406; H04L 9/30; H04L 63/06; H04L 9/3236; H04L 9/0643; H04L 9/3247

(57) ABSTRACT

One embodiment provides an apparatus. The apparatus includes an Internet of Things (IoT) device including a processor, a memory, a flash memory, a network interface and a boot Read Only Memory (ROM). A Root-of-Trust (RoT) application stored in the boot ROM causes the processor run the RoT after initialization of the IoT device. The RoT causes the device to determine a selected image by determining if an update mode is set. The RoT also causes the processor to load the selected image into memory and determine whether a verification of a signature of the selected image is successful. When the verification of the signature is successful then control is transferred to the selected image and when the verification is not successful then a recovery boot is performed

### TECHNICAL FIELD

The present disclosure relates to computer software, in particular to a Root-of-Trust (RoT) application that serves as a hardware-based anchor for secure boot and secure update targeting Internet of Things (IoT) devices.

### BACKGROUND

The Internet of Things (IoT) is becoming an increasingly popular platform for devices. IoT involves connecting any electronic device to the Internet (and/or to each other). This includes everything from cellphones, coffee makers, washing machines, headphones, lamps, wearable devices and the like. The IoT is a giant network of connected “things” (which also includes people).

Internet of Things (IoT) edge devices/sensors being deployed in agriculture, transportation etc., have become increasingly popular. To save power, these devices usually remain in a powered-down state and are powered-up as needed. Every time the device powers-up, a firmware verification takes place to ensure authenticity.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a diagram of Merkle tree consistent with several embodiments of the present disclosure;

FIG. 2 is a diagram of an example flash memory layout consistent with several embodiments of the present disclosure;

FIG. 3 is a flowchart of deployment rule operations according to various embodiments of the present disclosure;

FIG. 4 is a block diagram of an Internet of Things device.

Although the following Detailed Description will proceed with reference being made to illustrative embodiments, many alternatives, modifications, and variations thereof will be apparent to those skilled in the art.

### DETAILED DESCRIPTION

The present disclosure relates to a Root of Trust (RoT) application for energy-constrained Internet of Things (IoT) devices. An apparatus, system and method are configured to provide secure boot and update targeting of ultra-resource-constrained IoT devices. An example ultra-constrained device is a sensor used in farms. These sensors are expected to last for a long period of time by harvesting energy from its environment such as solar or wind.

The presently described ROT serves as a hardware-based anchor for secure boot and secure update targeting ultra-resource-constrained IoT devices. In particular the boot ROM code footprint for verification is about 2 KB and the latency is around 205 ms in one experiment configuration. This is believed to be the smallest RoT for IoT devices. Firmware verification uses a multi-time hash-based signature scheme compliant with the recently released candidate for standardization (IETF draft). The presently described approach is based on a multi-time hash-based signature scheme that allows the validation of all signatures with a single public-key and has very small code-footprint and performance better than conventional verification operations, which makes the presently described approach more suitable for ultra-resource-constrained devices.

In at least one embodiment, an Internet of Things (IoT) device includes a processor, a memory, a flash memory, a network interface and a boot Read Only Memory (ROM). A Root-of-Trust (RoT) application is stored in the boot ROM. The RoT application is run from the boot ROM after initialization of the IoT device. The RoT causes the device to perform several operations. The operations include determining a selected image by determining if an update mode is set. When the update mode is set the selected image comprises an update image and when the update mode is not set, the selected image comprises a first image. The boot Rom further causes the processor to load the selected image into memory and to determine whether a verification of a signature of the selected image is successful. When the verification of the signature of the selected image is successful then control is transferred to the selected image and when the verification of the signature of the selected image is not successful then a recovery boot is performed.

In at least one embodiment, a method comprises running a Root-of-Trust (RoT) from a boot Read Only Memory (ROM) after initialization of an Internet of Things (IoT) device. The RoT causes the IoT device to perform several operations. The operations include determining a selected image by determining if an update mode is set. When the update mode is set the selected image comprises an update image. When the update mode is not set, the selected image comprises a first image. The operations also include loading the selected image into memory and determining whether a verification of a signature of the selected image is successful. When the verification of the signature of the selected image is successful then control is transferred to the selected image. When the verification of the signature of the selected image is not successful then a recovery boot is performed.

In at least one embodiment a computer readable storage device has stored thereon instructions that when executed by the processor of the IoT device result in the following operations being performed. The instructions, when executed by the processor, cause the processor to run a Root-of-Trust (RoT) from a boot ROM after initialization of the Internet of Things (IoT) device. The RoT includes instructions for determining a selected image by determining if an update mode is set, wherein when the update mode is set the selected image comprises an update image and wherein when the update mode is not set, the selected image comprises a first image. The Rot further includes instructions for loading the selected image into memory and determining whether a verification of a signature of the selected image is successful. The Rot also includes instructions wherein when the verification of the signature of the selected image is successful then transferring control to the selected image and when the verification of the signature of the selected image is not successful then performing a recovery boot.

Prior RoT approaches are based on Rivest Shamir and Adleman (RSA) or Elliptic Curve Digital Signature Algorithm (ECDSA) for signature verification. The RSA-based solutions can achieve good performance (approximately 250 ms in one example configuration) in terms of latency but require large code size (approximately 6 KB). Error Correction Code (ECC) based solutions can be smaller (approximately 3 KB) but have 11 times worse latency. The traditional firmware authentication schemes based on ECC and/or RSA and require a large boot ROM or One Time Programmable (OTP)-flash and incur significant latency overhead, thus they are not suitable for this class of devices.

The presently described approach is based on a multi-time hash-based signature scheme that allows the validation of all signatures with a single public-key and has very small code-footprint and performance which is better than RSA, which makes the presently disclosed RoT more suitable for certain devices, including but not limited to, ultra-resource-constrained devices.

The RoT architecture includes the RoT running in boot ROM/OTP and interacting with the flash memory. One part of RoT is the use of a multi-time hash-based signature verification technique. In a particular embodiment an eXtended Merkle Signature Scheme/Winterniz One Time Signature (XMSS/WOTS+) is used. XMSS uses a Merkle tree to support signature verification multiple times with only one public key PK. A Merkle tree uses a complete binary tree for producing multiple one-time signatures associated to a single public key. In a Merkle tree every non-leaf node is labelled with the hash of the labels or values of its child nodes.

In WOTS+, a random integer number is generated as private key sk, and the public key PK is generated by calling a chain function that, among other things, applies a keyed hash function on sk for N times, where N is the maximum number of hashes that is allowed.

Signing a message to generate a signature is done by calling this chain function for sk which will then apply the keyed hash function on it (N−M) times, assuming message is an integer M. The verification process just needs to call this chain function again, now giving the signature as input, which will call the keyed hash function (N−M) times. The signature is authentic if and only if the output of this process matches with the original public key PK.

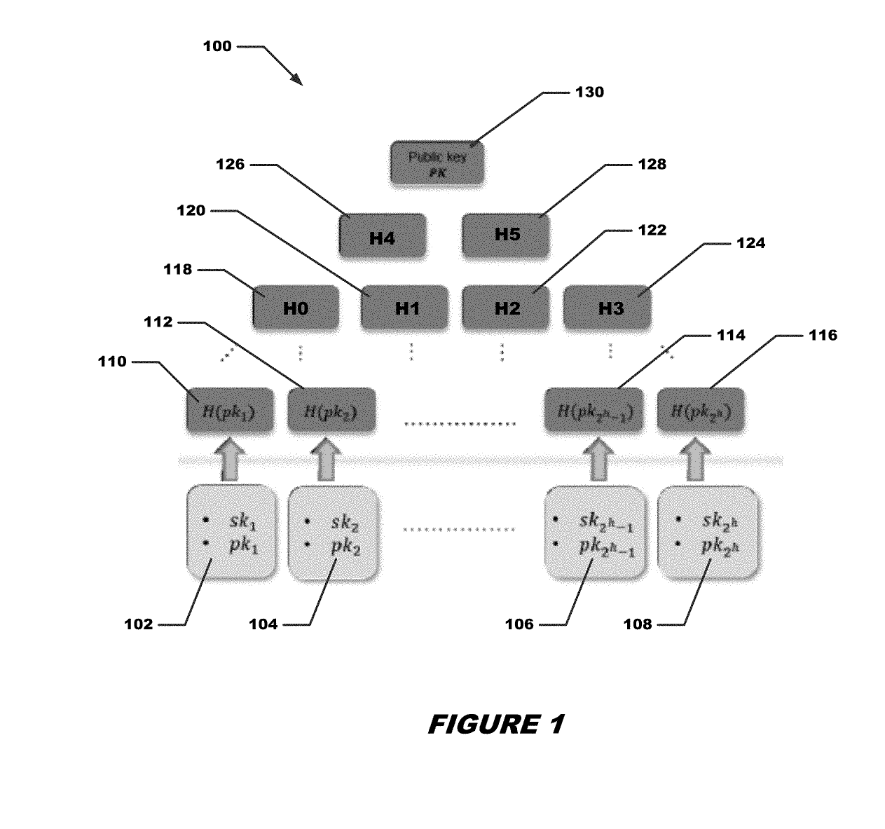

XMSS uses a Merkle tree, which is used to derive one public key PK and a group of private keys pks so that multiple messages can be verified using just one public key. An Example Merkle tree 100 is shown in FIG. 1. Each leaf node of the tree is a hashing of WOTS+ public key. Each of the rest of nodes is built by hashing and XORing its two children nodes. The root node is the group public key 130.

Data block 102 includes the private key sk₁ and public key pk₁, data block 104 includes private key sk₂ and public key pk₂, data block 106 includes the private key sk₂^{H}₋₁ and public key pk₂^{H}₋₁, and data block 108 includes private key sk₂^{H} and public key pk₂^{H}. These are the leaf nodes. Non-leaf node 110 comprises a hash of pk₁, non-leaf node 1112 comprises a hash of pk₂, non-leaf node 114 comprises a hash of pk₂^{H}₋₁, and non-leaf node 116 comprises a hash of pk₂^{H}. Non-leaf node 118 comprises a hash (H0) of the contents of the children nodes which have been XORed. Non-leaf node 118 therefore comprises a hash of the result of the XORing of H(pk₁) and H(pk₂). Non-leaf node 124 comprises a hash (H3) of the contents of the children nodes which have been XORed. Non-leaf node 124 therefore comprises a hash of the result of the XORing of H(pk₂^{H}₋₁) and H(pk₂^{H}). Non-leaf node 126 comprises a hash (H4) of the value in non-leaf node 118 XORed with the value in non-leaf node 120. Non-leaf node 128 comprises a hash (H5) of the value in non-leaf node 122 XORed with the value in non-leaf node 124. Non-leaf node 130 contains the hash (H5) of H4 XORed with H5. This produces the public key PK

To sign a message M, a node is first selected. Then in addition to the one time signature scheme described above, the authentication path associated with this node that is used to build the root node is also included as the final signature. The verification process first verifies the one time signature using the node's public key. It then computes the root node based on the authentication path, which is compared against the known group public key. In such a manner, a multi-time signature scheme using a one time signature is established. The merkle tree's height h determines the total number private keys that can be used to sign different messages verified by one group public key. For example, a tree height with 16 can support up to 64 K times of different image signing. Once the tree is built up and keys are generated, the public key along with the RoT will be stored into the boot ROM.

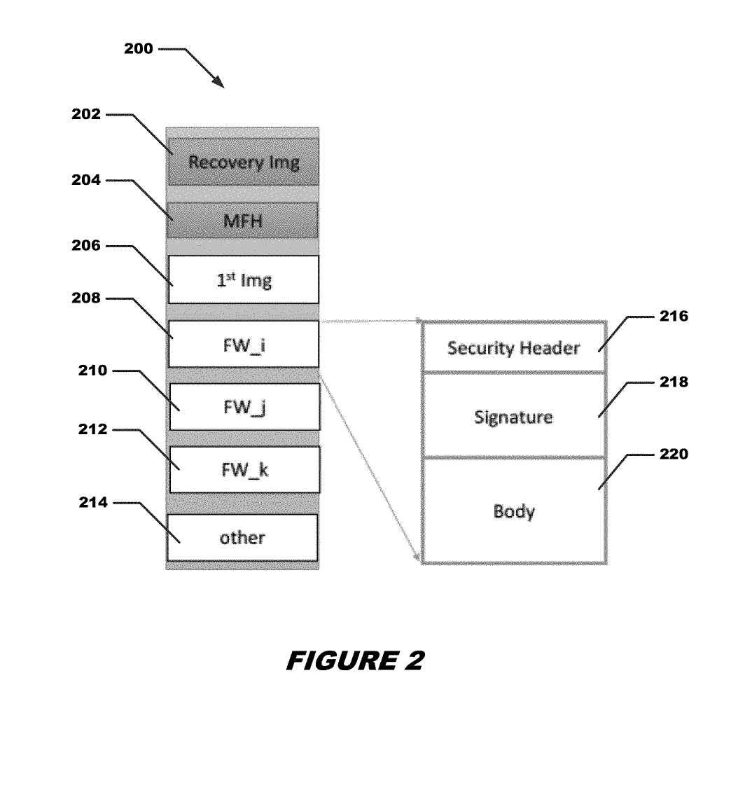

FIG. 2 shows an example layout of the flash memory 200, which includes recovery image 202, a Master Flash Header (MFH) 204 and firmware images 206, 208, 210, 212 and 214. The MFH 204 indicates properties of each image including type, size, location etc. Each firmware image has a security header 216, signature 218 and image body 220. The signature size is dependent on the parameters chosen for XMSS/WOTS+.

The secure boot process starts with RoT, which loads and verifies the first image 206, and the first image will load and verify the subsequent firmware images 208, 210, 212 and 214. This establishes a chain of trust. In one example, the first image 206 is used for configuration of system registers and scheduling, Bluetooth Low Energy (BLE) firmware for communication, other firmware like image recognition for example, and etc.

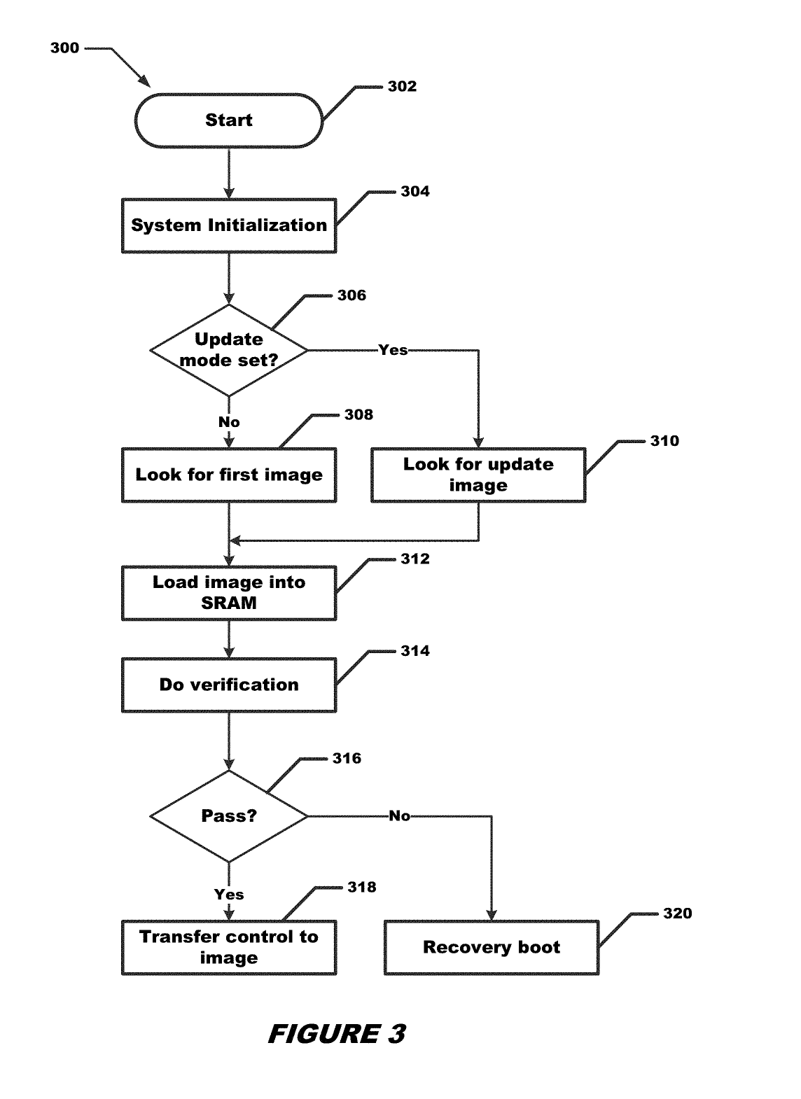

FIG. 3 shows the boot flow 300 of RoT in detail. Once the core is released from reset, it starts running the RoT from boot ROM 302. System initialization is performed 304. System initialization initializes the system by performing various tasks such as disabling interrupts and setting a stack pointer.

A determination is made regarding whether an update mode is set 306. When the determination is made that an update mode is not set, a first image in the flash memory is looked for 308. This is a normal boot scenario. When the determination is made that an update mode is not set, an update image is looked for 310. The update image is responsible for verifying a new firmware patch.

After looking and finding either the first image or the update image, the selected image is loaded from flash memory into regular memory 312. A verification of the selected image is performed 314. The XMSS/WOTS+ signature scheme is used to do signature verification.

A determination is then made regarding whether the verification passed 316. When the result of the verification is that the image passed, control is transferred to the loaded image 318. When the result of the verification is that the image did not pass, a recovery image is loaded 320. For example, the recovery image may provide a means to diagnose the device.

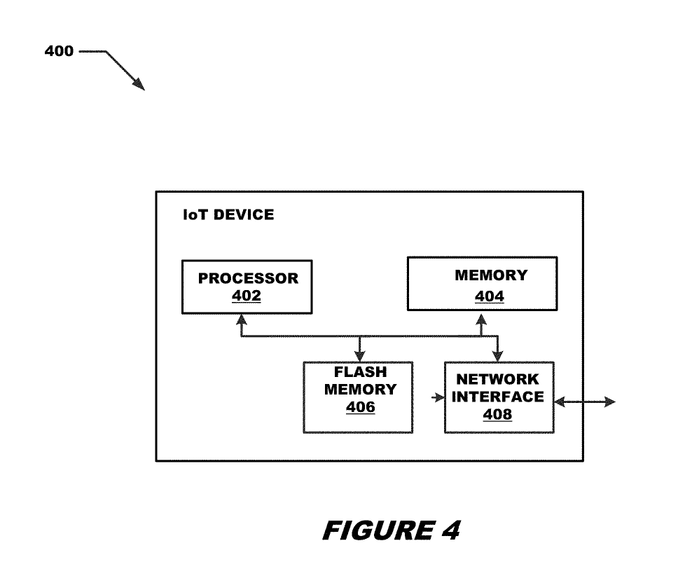

FIG. 4 illustrates a computer system, in this example an IoT device 400. The IoT device 400 includes a processor 402, a memory 404, a network interface 408, and flash memory 406. The processor 402 is capable of processing instructions for execution within the IoT device 400. The processor 402 is capable of processing instructions stored in the memory 404 or in the flash memory 406.

The memory 404 stores information within the IoT device 400. The memory 404 may include any volatile or non-volatile memory or other computer-readable medium, including without limitation a Random Access Memory (RAM), a Read Only Memory (ROM), a Programmable Read-only Memory (PROM), an Erasable PROM (EPROM), registers, and so forth. The memory 404 may store program instructions, program data, executables, and other software and data useful for controlling operation of the IoT device 400 and configuring the device 400 to perform functions. The memory 404 may include a number of different stages and types for different aspects of operation of the IoT device 400. For example, a processor may include on-board memory and/or cache for faster access to certain data or instructions, and a separate, main memory or the like may be included to expand memory capacity as desired.

The network interface 408 may include any hardware and/or software for connecting the IoTdevice 400 in a communicating relationship with other resources through a network. This may include remote resources accessible through the Internet, as well as local resources available using short range communications protocols using, e.g., physical connections (e.g., Ethernet), radio frequency communications (e.g., WiFi), optical communications, (e.g., fiber optics, infrared, or the like), ultrasonic communications, or any combination of these or other media that might be used to carry data between the IoT device 400 and other devices. The network interface 408 may, for example, include a router, a modem, a network card, an infrared transceiver, a radio frequency (RF) transceiver, a near field communications interface, a radio-frequency identification (RFID) tag reader, or any other data reading or writing resource or the like.

As used in any embodiment herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

The foregoing provides example system architectures and methodologies, however, modifications to the present disclosure are possible. The processor may include one or more processor cores and may be configured to execute system software. System software may include, for example, an operating system. Device memory may include I/O memory buffers configured to store one or more data packets that are to be transmitted by, or received by, a network interface.

Thus, the present disclosure is directed to an apparatus, system and method configured to run a Root-of-Trust (RoT) from a boot Read Only Memory (ROM) after initialization of an Internet Of Things (IoT) device. The RoT causes the device to perform the operations of determining a selected image by determining if an update mode is set, wherein when the update mode is set the selected image comprises an update image and wherein when the update mode is not set, the selected image comprises a first image; loading the selected image into memory; determining whether a verification of a signature of the selected image is successful; and when the verification of the signature of the selected image is successful then transferring control to the selected image and when the verification of the signature of the selected image is not successful then performing a recovery boot.

The following examples pertain to further embodiments. The following examples of the present disclosure may comprise subject material such as a device, a method, at least one machine-readable medium for storing instructions that when executed cause a machine to perform acts based on the method, means for performing acts based on the method and/or a IoT device and RoT application, as provided below.

### EXAMPLE 1

According to this example there is provided an apparatus. The apparatus includes an Internet of Things (IoT) device including a processor, a memory, a flash memory, a network interface and a boot Read Only Memory (ROM). The apparatus further includes a Root-of-Trust (RoT) application stored in the boot ROM wherein the RoT application causes the processor to perform operations. The operations include determining a selected image to run, and verifying a signature of the selected image.

### EXAMPLE 2

This example includes the elements of example 1, further including the operation of transferring control to the selected image when the verification of the signature of the selected image is successful.

### EXAMPLE 3

This example includes the elements of example 2, further including the operation of performing a recovery boot when the verification of the signature of the selected image is not successful.

### EXAMPLE 4

This example includes the elements of example 1, wherein the RoT verification application resides in less than 2 KiloBytes (KB) of memory.

### EXAMPLE 5

This example includes the elements of example 1, wherein the RoT verification application has a latency of about 205 milliseconds.

### EXAMPLE 6

This example includes the elements of example 1, wherein the operation of verifying a signature of the selected image includes a multi-time hash-based signature process.

### EXAMPLE 7

This example includes the elements of example 6, wherein the operation of verifying a signature of the selected image includes a multi-time hash-based signature process including use of a single public key.

### EXAMPLE 8

This example includes the elements of example 6 and example 7, wherein the operation of verifying of a signature of the selected image includes use of a one-time hash-based signature process.

### EXAMPLE 9

This example includes the elements of example 6, example 7 and example 8, wherein the operation of verifying of a signature of the selected image includes use of an eXtended Merkle Signature Scheme/Winterniz One Time Signature (XMSS/WOTS+) process.

### EXAMPLE 10

This example includes the elements of example 1 and example 2, further including the operation of loading the selected image.

### EXAMPLE 11

This example includes the elements of example 1, example 2 and example 10 further including the operation of verifying at least one subsequent image.

### EXAMPLE 12

This example includes the elements of example 1 wherein the selected image comprises an update image.

### EXAMPLE 13

This example includes the elements of example 1 and example 12 wherein the update image verifies a firmware patch.

### EXAMPLE 14

According to this example there is provided a method. The method includes running by an Internet of Things (IoT) a Root-of-Trust (RoT) application stored in the boot ROM wherein the RoT application causes the processor to perform operations. The operations include determining a selected image to run, and verifying a signature of the selected image.

### EXAMPLE 15

This example includes the elements of example 14, further including transferring control to the selected image when the verification of the signature of the selected image is successful.

### EXAMPLE 16

This example includes the elements of example 15, further including performing a recovery boot when the verification of the signature of the selected image is not successful.

### EXAMPLE 17

This example includes the elements of example 14, wherein the running the RoT verification application in less than 2 KiloBytes (KB) of memory.

### EXAMPLE 18

This example includes the elements of example 14, wherein the running the RoT verification application has a latency of about 205 milliseconds.

### EXAMPLE 19

This example includes the elements of example 14, wherein the verifying a signature of the selected image includes using a multi-time hash-based signature process.

### EXAMPLE 20

This example includes the elements of example 19, wherein the verifying a signature of the selected image using a multi-time hash-based signature process further comprises using a single public key.

### EXAMPLE 21

This example includes the elements of example 19 and example 20, wherein verifying of a signature of the selected image includes using a one-time hash-based signature process.

### EXAMPLE 22

This example includes the elements of example 19, example 20 and example 21, wherein verifying of a signature of the selected image includes using an eXtended Merkle Signature Scheme/Winterniz One Time Signature (XMSS/WOTS+) process.

### EXAMPLE 23

This example includes the elements of example 14 and example 15, further including loading the selected image.

### EXAMPLE 24

This example includes the elements of example 14, example 15 and example 23 further including verifying at least one subsequent image.

### EXAMPLE 25

This example includes the elements of example 14 wherein running the selected image comprises running an update image.

### EXAMPLE 26

This example includes the elements of example 14 and example 25 wherein running the update image includes verifying a firmware patch.

### EXAMPLE 27

According to this example, there is provided a computer readable storage device. The device has stored thereon instructions for a Root-of-Trust (RoT) application that when executed by one or more Internet of Things (IoT) processors result in the following operations including: determining a selected image to run, and verifying a signature of the selected image.

### EXAMPLE 28

This example includes the elements of example 27, wherein the instructions that when executed by one or more processors results in the following additional operations including transferring control to the selected image when the verification of the signature of the selected image is successful.

### EXAMPLE 29

This example includes the elements of example 15, wherein the instructions that when executed by one or more processors results in the following additional operations including performing a recovery boot when the verification of the signature of the selected image is not successful.

### EXAMPLE 30

This example includes the elements of example 27, wherein the instructions that when executed by one or more processors results in the following additional operations including running the RoT verification application in less than 2 KiloBytes (KB) of memory.

### EXAMPLE 31

This example includes the elements of example 27, wherein the instructions that when executed by one or more processors results in the following additional operations including wherein the running the RoT verification application has a latency of about 205 milliseconds.

### EXAMPLE 32

This example includes the elements of example 27, wherein the instructions that when executed by one or more processors results in the following additional operations including verifying a signature of the selected image using a multi-time hash-based signature process.

### EXAMPLE 33

This example includes the elements of example 32, wherein the instructions that when executed by one or more processors results in the following additional operations including verifying a signature of the selected image using a multi-time hash-based signature process using a single public key.

### EXAMPLE 34

This example includes the elements of example 32 and example 33, wherein the instructions that when executed by one or more processors results in the following additional operations including verifying of a signature of the selected image using a one-time hash-based signature process.

### EXAMPLE 35

This example includes the elements of example 32, example 33 and example 34, wherein the instructions that when executed by one or more processors results in the following additional operations including verifying of a signature of the selected image using an eXtended Merkle Signature Scheme/Winterniz One Time Signature (XMSS/WOTS+) process.

### EXAMPLE 36

This example includes the elements of example 27 and example 28, wherein the instructions that when executed by one or more processors results in the following additional operations including loading the selected image.

### EXAMPLE 37

This example includes the elements of example 27, example 28 and example 29 wherein the instructions that when executed by one or more processors results in the following additional operations including verifying at least one subsequent image.

### EXAMPLE 38

This example includes the elements of example 27 wherein the instructions that when executed by one or more processors results in the following additional operations including running an update image.

### EXAMPLE 39

This example includes the elements of example 27 and example 38 wherein the instructions that when executed by one or more processors results in the following additional operations including verifying a firmware patch.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. An apparatus comprising:
an Internet of Things (IoT) device including a processor, a memory, a flash memory, a network interface and a boot Read Only Memory (ROM);
a Root-of-Trust (RoT) application stored in the boot ROM wherein the RoT application causes the processor to perform the operations of:
running the RoT from the boot ROM after initialization of the IoT device, the RoT causing the device to perform the operations:
determining a selected image by determining if an update mode is set, wherein when the update mode is set the selected image comprises an update image and wherein when the update mode is not set, the selected image comprises a first image;
loading the selected image into memory;
determining whether a verification of a signature of the selected image is successful using a multi-time hash-based signature process; and
when the verification of the signature of the selected image is successful then transferring control to the selected image and when the verification of the signature of the selected image is not successful then performing a recovery boot.

2. The apparatus of claim 1, wherein the processor running an RoT application comprises the processor running an RoT verification application residing in less than 2 KiloBytes (KB) of memory.

3. The apparatus of claim 1, wherein the processor running an RoT application comprises the processor running an RoT verification application having a latency of about 205 milliseconds.

4. The apparatus of claim 1, wherein the processor using a multi-time hash-based signature process further comprises the processor using a single public key.

5. The apparatus of claim 4, wherein the processor determining whether a verification of a signature of the selected image is successful further comprises the processor using a one-time hash-based signature process.

6. The apparatus of claim 5, wherein the processor using a one-time hash-based signature process comprises the processor using an eXtended Merkle Signature Scheme/Winterniz One Time Signature (XMSS/WOTS+) process.

7. The apparatus of claim 1, wherein when the processor determining verification of the signature of the selected image is successful then transferring control to the image further comprises the processor loading the selected image and verifying at least one subsequent image.

8. The apparatus of claim 1, wherein when the selected image comprises an update image then the processor runs the update image to verify a firmware patch.

9. A method comprising:
running a Root-of-Trust (RoT) from a boot Read Only Memory (ROM) after initialization of an Internet Of Things (IoT) device, the RoT causing the device to perform the operations:
determining a selected image by determining if an update mode is set, wherein when the update mode is set the selected image comprises an update image and wherein when the update mode is not set, the selected image comprises a first image;
loading the selected image into memory;
determining whether a verification of a signature of the selected image is successful using a multi-time hash-based signature process; and
when the verification of the signature of the selected image is successful then transferring control to the selected image and when the verification of the signature of the selected image is not successful then performing a recovery boot.

10. The method of claim 9, wherein the running an RoT application comprises running an RoT verification application residing in less than 2 KiloBytes (KB) of memory.

11. The method of claim 9, wherein the running an RoT application comprises running an RoT verification application having a latency of about 205 milliseconds.

12. The method of claim 9, wherein the using a multi-time hash-based signature process further comprises using a single public key.

13. The method of claim 12, wherein the determining whether a verification of a signature of the selected image is successful further comprises using a one-time hash-based signature process.

14. The method of claim 12, wherein the one-time hash-based signature process comprises an eXtended Merkle Signature Scheme/Winterniz One Time Signature (XMSS/WOTS+) process.

15. The method of claim 9, wherein when the verification of the signature of the selected image is successful then transferring control to the image further comprises loading the selected image and verifying at least one subsequent image.

16. The method of claim 9, wherein when the selected image comprises an update image then running the update image to verify a firmware patch.

17. A computer readable storage device having stored thereon instructions that when executed by one or more processors result in the following operations comprising:
running a Root-of-Trust (RoT) from a boot Read Only Memory (ROM) after initialization of an Internet Of Things (IoT) device, the RoT causing the device to perform the operations:
determining a selected image by determining if an update mode is set, wherein when the update mode is set the selected image comprises an update image and wherein when the update mode is not set, the selected image comprises a first image;
loading the selected image into memory;
determining whether a verification of a signature of the selected image is successful using a multi-time hash-based signature process; and
when the verification of the signature of the selected image is successful then transferring control to the selected image and when the verification of the signature of the selected image is not successful then performing a recovery boot.

18. The device of claim 17, wherein the instructions that when executed by one or more processors further comprises running an RoT verification application residing in less than 2 KiloBytes (KB) of memory.

19. The device of claim 17, wherein the instructions that when executed by one or more processors further comprises running an RoT verification application having a latency of about 205 milliseconds.

20. The device of claim 17, wherein the instructions that when executed by one or more processors using a multi-time hash-based signature process further comprises using a single public key.

21. The device of claim 17, wherein the instructions that when executed by one or more processors determining whether a verification of a signature of the selected image is successful further comprises using a one-time hash-based signature process.

22. The device of claim 21, wherein the instructions that when executed by one or more processors further comprises wherein the one-time hash-based signature process comprises an eXtended Merkle Signature Scheme/Winterniz One Time Signature (XMSS/WOTS+) process.

23. The device of claim 17, wherein the instructions that when executed by one or more processors further comprises wherein when the verification of the signature of the selected image is successful then transferring control to the image then loading the selected image and verifying at least one subsequent image.

24. The device of claim 17, wherein the instructions that when executed by one or more processors further comprises wherein when the selected image comprises an update image then running the update image to verify a firmware patch.
